(19) United States
(12) Patent Application Publication
(10) Pub. No.: US 2003/0021927 A1
(43) Pub. Date: Jan. 30, 2003

(54) Method of blow and vacuum molding insulated containers

(75) Inventor: James Michael Boenig, Seguin, TX (US)

Correspondence Address: MICHALIK & WYLIE PLLC, Suite 103, 14645 Bel-Red Road, Bellevue, WA, 98007, US

(73) Assignee: The Coleman Company, Inc.

(21) Appl. No.: 09/918,785

(22) Filed: Jul. 30, 2001

(51) Int. Cl. B65D 1/00; F16L 1/00; B29C 44/06; B29C 49/04

(52) U.S. Cl. 428/36.5; 264/515; 264/45.1; 264/51; 264/54; 264/540; 264/571

(57) ABSTRACT

A method for producing an insulated container using a modified blow molding process. A multi-layer parison is created that includes inner layer, a thermoplastic foamed resin central layer, and an outer layer. The parison is clamped between halves of female mold, and a gas, e.g., air, is briefly blown into the interior of the clamped parison section to expand the parison section to substantially against the outer walls of the mold. Vacuum is applied through the mold walls to hold the clamped parison section in place, and the gas pressure is released. By removing the gas pressure, the clamped parison section is permitted to mold without internal pressures. That is, the vacuum holds the parison section in place, without air pressure crushing, or pressing against, the inner layer of the parison. In this manner, the foamed central layer is free to expand.

### FIELD OF THE INVENTION

The present invention relates generally to extrusion of polymeric materials, and more particularly to extrusion of a multiple-layer, insulated product.

### BACKGROUND OF THE INVENTION

Coolers and insulated containers are quite popular, and are used in numerous activities. Large coolers are often seen in picnics and other social gatherings, and individual users utilize smaller coolers and insulated containers, such as to transport soup to work or to maintain a beverage at a cooler temperature during a sporting activity.

Typically, the walls of contemporary coolers and insulated containers (hereinafter, for ease of discussion, collectively referred to as “insulated containers”) include hard outer and inner shells, and an insulating central layer. The central layer is usually a product having a high insulation value, or R value, such as expanded polystyrene or polyurethane.

For most contemporary insulated containers, the outer and inner layers of the insulated containers are each formed in separate vacuum, injection, or blow molding machines. Liquid polyurethane is then manually placed between the inner and outer layers, and is permitted to expand to fill the void between the two layers. Alternatively, molded polystyrene foam is manually placed in the void between the two layers. The result is a container having smooth, hard, outer and inner surfaces, and an insulating central core. The outer layer protects the container and central core, and provides an attractive surface. The inner layer separates the central core from the contents of the container, and provides an impermeable layer so that liquids may be stored in the container.

Although insulated containers work well for their intended purpose, the above-described process for the producing insulated containers is expensive and time-consuming. The two separate molding machines and the station for adding the polystyrene require an enormous amount of valuable plant floor space. Moreover, assembling the inner and outer shells with the polystyrene requires time-consuming, and therefore expensive, labor.

In addition to the above drawbacks, contemporary insulated containers will become increasingly more expensive to manufacture because of the Environmental Protection Agency (EPA) regulations that are to be imposed over the coming years. For example, fluorocarbons are typically used as blow agents for polyurethane, and the use of such blow agents is being limited by current EPA regulations. The use of alternative blow agents is expensive, and often produces a lower performing product.

### SUMMARY OF THE INVENTION

The present invention provides a method of forming an insulated container in a single station molding process. By producing the insulated container in this one station, the method of the present invention overcomes many of the deficiencies of the prior art described above.

In accordance with one aspect of the invention, the insulated container of the present invention is produced using a modified blow molding process. A multi-layer parison is created that includes inner layer, a thermoplastic foamed resin central layer, and an outer layer. The parison is clamped between halves of a female mold, and a gas, e.g., air, is briefly blown into the interior of the clamped parison section to expand the parison section to substantially against the outer walls of the mold. Vacuum is applied against the mold walls to hold the clamped parison section in place.

Preferably, the gas is blown into the clamped parison section at a pressure and volume that is sufficient to expand the clamped parison section, but that is not so overwhelming to crush or prevent expansion of the thermoplastic foamed resin central layer. After the clamped parison section is blown against the sides of the mold and the vacuum is supporting the parison section, there is no need to blow further gas into the parison section, so the gas pressure may be removed.

By removing the gas pressure, the clamped parison section is permitted to mold without internal pressures. That is, the vacuum holds the parison section in place, without air pressure crushing, or pressing against, the inner layer of the parison. In this manner, the foamed central layer is free to expand. The vacuum maintains the outer layer of the clamped parison section against the inner surface of the mold, and thus the outer contour of the insulated container may be defined with relative precision.

In accordance with one aspect of the present invention, the central layer is foamed low density polyethylene (LDPE) with long chain branching characteristics. The inner and outer layers are preferably high density polyethylene (HDPE) or high load melt index high density polyethylene (HLMI HDPE).

The modified blow molding process of the present invention overcomes many of the deficiencies of the prior art methods for producing insulated containers. For example, the insulated container may be formed in one blow-molding machine, as opposed to the two molding machines and the polystyrene or polyurethane assembly station of the prior art, and thus the method of the present invention saves valuable plant floor space. In addition, the insulated container formed by the process of the present invention does not require additional assembly, and thus reduces labor costs over prior art methods. Moreover, the process is utilized with plastic polymers, and thus avoids potential environmental problems and/or costs involved with expansion of polyurethane.

Other advantages will become apparent from the following detailed description when taken in conjunction with the drawings, in which:

### BRIEF DESCRIPTION OF THE DRAWINGS

FIG. 1 is a front, partial-cutaway view of an extrusion die head for producing a parison in accordance with one aspect of the present invention;

FIG. 2 is a representation of a die molding machine for use with the die head of FIG. 1;

FIG. 3 is a front view of the extrusion die head of FIG. 1, shown with part of a parison being formed;

FIG. 4 is front view of the bottom of the die head of FIG. 3, shown with the parison being further formed, and two female mold halves beginning to close on the parison;

FIG. 5 is a partial-cutaway, front view of the die head of FIG. 3, with the two female mold halves closed and showing a beginning of the application of air inside the parison;

FIG. 6 is a partial-cutaway, front view of the die head of FIG. 3, similar to FIG. 5, with additional air added in the parison, and vacuum applied to the female mold halves;

FIG. 7 is a partial-cutaway, front view of the die head of FIG. 3, similar to FIG. 5, with air pressure released inside the parison, and vacuum pressure remaining;

FIG. 8 shows the die head of FIG. 3 with the two mold halves removed from the parison and parts of the parison machined away to form an insulated container; and

FIG. 9 shows the completed insulated container of FIG. 8, with the container removed from the die head.

### DETAILED DESCRIPTION

The process of the present invention utilizes a modified blow molding process to produce insulated containers. As is known, in extrusion blow molding of hollow articles of polymeric resins, a tube or parison of polymeric resin is formed by extruding plastic polymer through an extrusion die. A section of this parison is then introduced into a mold and, by gas pressure, expanded against the walls of the mold. Blow molding processes are typically used to produce plastic bottles, containers, and many other hollow shapes. In the present invention, however, a multi-layer parison is formed and molded resulting in a product that has one layer that exhibits exemplary insulating properties. In accordance with one aspect of the present invention, as described further below, the insulating layer is formed by providing a foamed layer in the multi-layer parison.

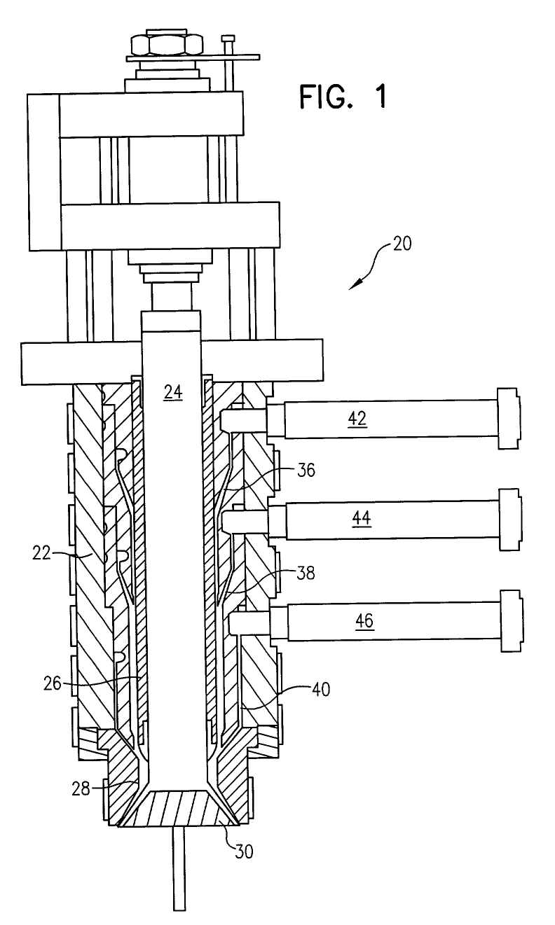

FIG. 1 shows a die head 20 that may be used in the practice of the process of the present invention. The die head 20 has a vertically aligned housing 22, and a vertically movable stem 24 positioned within a fixed tubular mandrel 26 within housing 22. The housing 22 includes an outwardly flared bushing or opening 28 in its lower end.

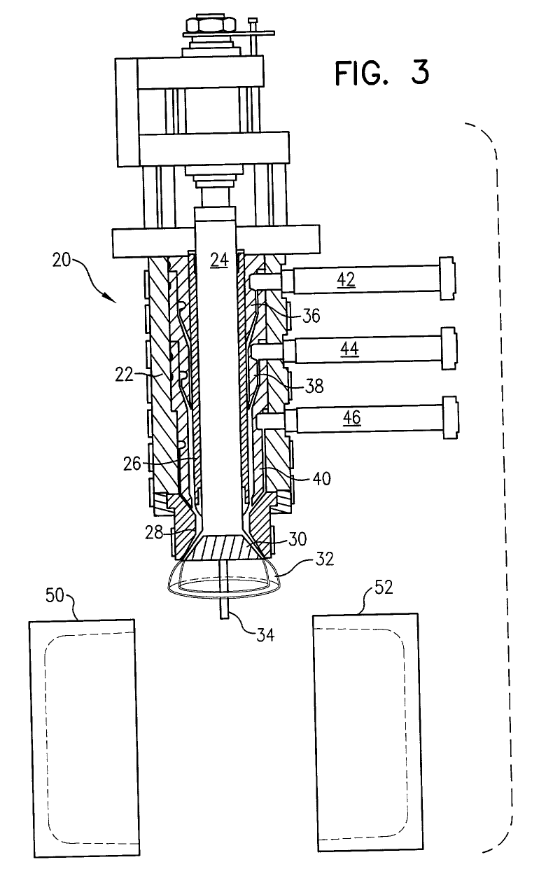

The stem 24 terminates in a pin or end 30, which extends through the bushing 28. The stem 24 is vertically adjustable, so that the space between the pin 30 and the bushing 28 may be adjusted. When in a raised position, the pin 30 engages the wall of the bushing 28 to close the extrusion orifice (FIG. 1). As described further below, in operation of the present invention, the pin 30 is lowered to a position (FIG. 3) so that a multi-layer parison 32 may be extruded through the gap (“die head orifice”) between the bushing 28 and the pin 30. To this end, when in the lowered position, the gap between the wall of the bushing 28 and the wall of pin 30 is approximately equal to the thickness of the wall of the multi-layer parison 32 as it is extruded.

A hollow tube 34 extends from the bottom of the pin 30. The hollow tube 34 is connected to a pressurized air source, such as an air compressor (not shown, but known in the art). The hollow tube 34 is arranged and configured so that it extends inside the multi-layer parison 32 as the parison is extruded.

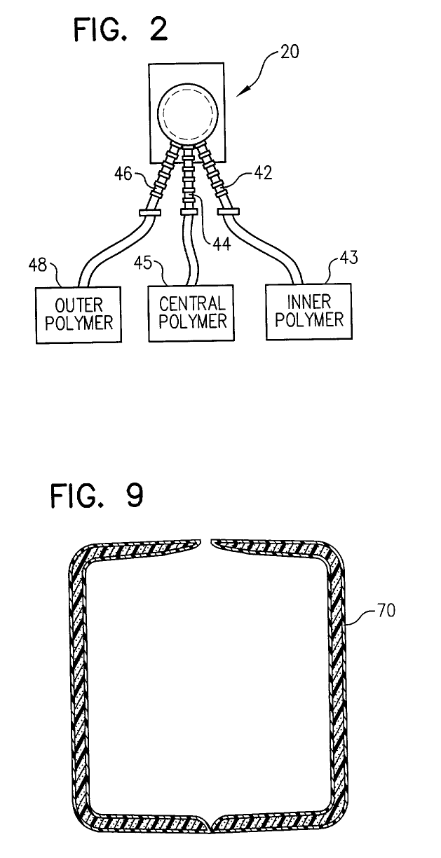

The die head 10 includes an inner resin conduit 36, an intermediate resin conduit 38 and an outer resin conduit 40. A first tubular connector 42 connects the inner resin conduit 36 to an inner polymer supply 43 (FIG. 2). A second tubular connector 44 connects the intermediate resin conduit 38 to a central polymer supply 45 (FIG. 2), and a third tubular connector 46 connects the outer resin conduit 40 to an outer polymer supply 48.

The inner polymer supply 43, the outer polymer supply 48, and the central polymer supply 45 are designed to provide plasticized polymer resins. The plasticized resins may be formed, for example, in plasticizing extruders, in which pellets of polymer resin are melted while being conveyed and sheered by a screw through an elongated cylinder. The use of plasticizing extruders in a multi-layer parison extrusion system is shown and described in U.S. Pat. No. 5,840,232, incorporated herein by reference. If plasticizing extruders are used with the die head 20, a continuous parison (e.g., the parison 32) is formed that is moved along the stem 24 and out of the die head orifice. In this manner, succeeding segments of the parison may be clamped between opposed mold sections to form successive parts.

The multi-layer parison 32 of the present invention may be produced using other dies and/or other plasticized polymer supplies. As one alternative to the die head 20 and screw extruders, the multi-layer parison 32 may be intermittently extruded by first collecting a charge or “shot” of the resins in an accumulator die head, and forcing the charge from the die head through an extrusion die to form a multi-layer parison of the desired length. The extruded parison is then clamped and molded, and the procedure is repeated.

Left and right female mold halves 50, 52 are mounted below and on opposite sides of the die head 20 (FIG. 3). The left and right female mold halves 50, 52 include reciprocating arms (not shown, but known in the art) that permit the two mold halves to be pressed and clamped together. Each of the mold halves 50, 52 includes a slot (not shown) in its upper center so that the hollow tube 34 is surrounded by the respective slots when the mold halves are closed and the pin 30 is in the lowered position. The mold halves 50, 52 also include vacuum vents 54 (FIG. 5) distributed throughout the mold. The vacuum vents 54 are connected to a vacuum system (not shown, but known in the art).

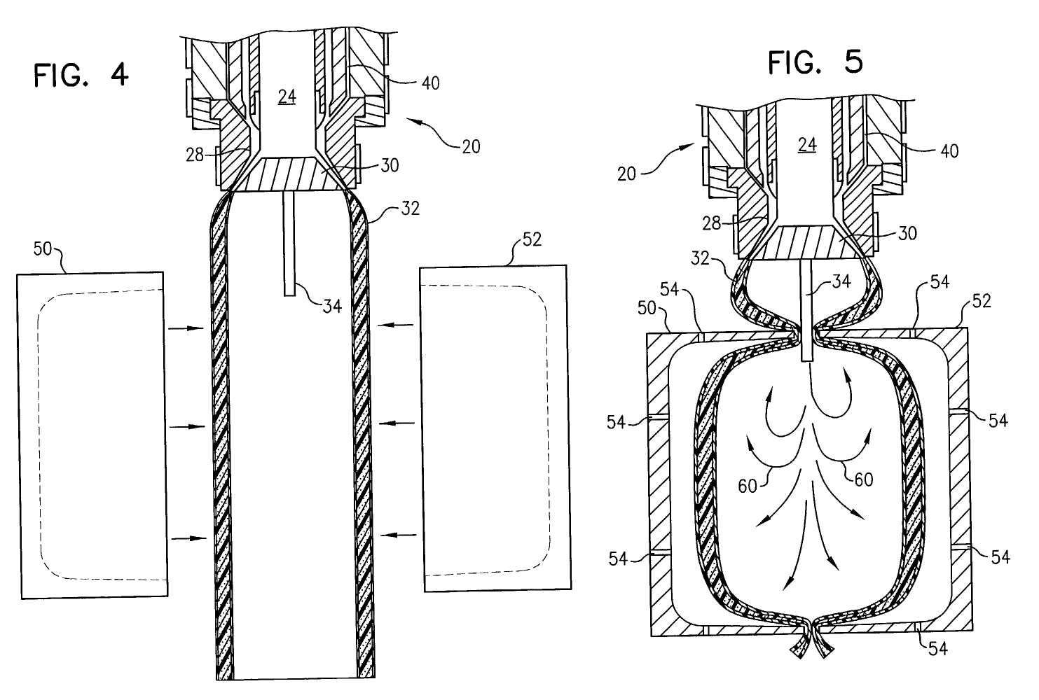

During operation, the inner polymer supply 43, the outer polymer supply 48, and the central polymer supply 45 provide plasticized resin into the resin conduits 36, 38, 40. When the desired quantities of resin have been collected, the stem 24 is lowered to form the desired parison orifice, and the resin is forced into the die head under pressure (e.g., at 750 to 6000 p.s.i.) to force the resin through the conduits 36, 38 and 40, respectively. Resin flowing through the conduit 36 forms a tube and flows further downwardly to join an intermediate tube formed in the conduit 38. The combined layers then join a tube formed in the conduit 40. The resin tubes for the inner layer, the central layer, and the outer layer are coaxial, sharing a central axis with the stem 24. The combined tubular resin layers are then forced through the orifice formed by the wall of bushing 28 and the wall of stem pin 30 to form the multi-layer parison 32 (a beginning stage of formation of the multi-layer parison 32 is shown in FIG. 3). Die swell causes the walls of the multi-layer parison 32 to grow larger after it leaves the orifice (FIG. 3), and, as the parison 32 gains length, it eventually has a substantially constant diameter (FIG. 4). In addition, as described further below, the central layer, which includes foaming additives (e.g., blow agents), expands as the polymer is foamed.

The inner polymer, outer polymer, and central polymer are chosen for a given application. In general, however, in accordance with one aspect of the present invention, at least one of the layers is a foamed thermoplastic resin, and is designed to have insulating properties. In the presently described embodiment, the central layer is a foamed thermoplastic resin, and the inner and outer layers are selected to be a strong, durable, plastic covering. However, the present invention may be utilized to produce several different types of insulated products, with the insulating foamed thermoplastic resin layer being any (or multiple layers of) a product having any number of layers.

In any event, for the embodiment shown in the drawings, the inner and outer polymers are chosen to have a strong, water-impermeable surface, and the outer polymer is chosen so that it may provide close outer part tolerances. In addition, the inner and outer polymers should resist the tendency of the multi-layer parison distorting or sagging due to its higher weight, since the parison, as it hangs down from the die head, tends to be pulled downwardly during the lengthy time period required to complete extrusion.

An example of an exemplary material that may be used for the inner and outer polymers is high density polyethylene (HDPE). This polymer exhibits a high hang strength and provides a good sealing structure and part definition for an insulated container. When the insulated container to be formed is of a large size, High Load Melt Index (HLMI) high density polyethylene (HDPE) may be used, because such material exhibits an even a higher hang strength.

The central layer is preferably a foamed thermoplastic, or plastic, polymer resin, and more preferably is foamed low density polyethylene (LDPE). Preferably, the low density polyethylene has long chain branching characteristics, because it has been found that low density polyethylene having such characteristics has exemplary foaming capabilities. Applicant has found the following low density polyethylenes to work well for foaming: Mobil's HDA 303B, and Chevron's 5619, but others may be used.

An endothermic or exothermic blowing agent may be used to foam the plastic polymer. The following blowing agents have been found to work well in providing foamed plastic layers of low density polyethylene: Clariant CF40, Reedy International FP50 and FPE50, and BI Chemicals EX127, but others may be used.

It is been found that use of the foregoing materials provides exemplary foam core densities. In fact, using the above materials, the process of the present invention has produced foam core densities that represent approximately a 75% reduction in weight of the low density polyethylene, compared to previous industry benchmarks of 40 to 50% reductions in density.

After the multi-layer parison 32 has been extruded a sufficient amount, the left and right mold halves 50, 52 are clamped around a section of the parison (FIG. 5). A gas (e.g., air) is blown into the parison section by the hollow tube 34, as indicated by the arrows 60 in FIG. 5.

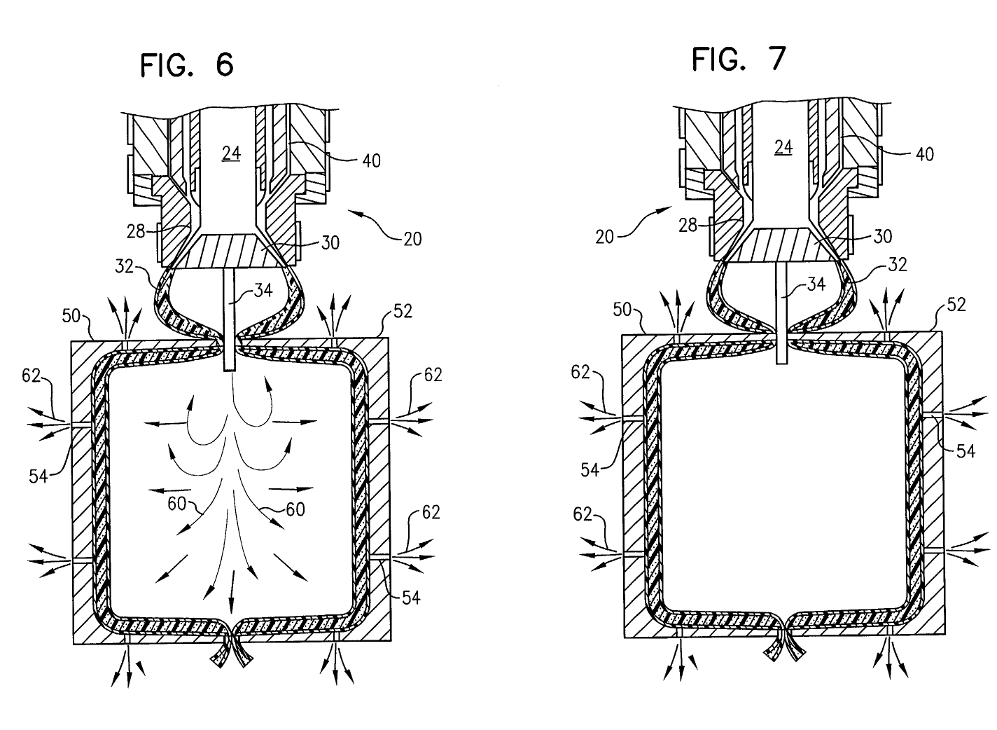

As can be seen in FIG. 6, the gas continues to blow until the parison section abuts the inside faces of the left and right mold halves 50, 52. Vacuum is applied (indicated by the arrows 62 in FIG. 6) prior to the parison section arriving against the inside faces of the left and right mold halves 50, 52 so that the vacuum may aid in aligning the parison section against the inner edges of the mold.

The gas supplied by the hollow tube may be supplied from any number of locations so as to inject gas into the center of the parison section. For example, a tube may be inserted into the side of the parison section, or may come up through the bottom portion of the section. A person of skill in the art may arrange and align the air supply in accordance with the part definition needed and the particular part and die head configuration.

In accordance with one aspect of the present invention, the volume and pressure of the gas supplied by the hollow tube is only sufficient enough to align the parison section against the inner faces of the left and right mold halves 50, 52 so that the vacuum may then support the parison section. Preferably, in accordance with one aspect of the present invention, the pressure supplied during this blowing stage is approximately 50 to 100 psi, and more preferably is approximately 50 psi. However, different pressures may be utilized according to the size and length of the parison, the location of blow tubes in the parison, the mold shape, the weight of the parison, and other factors.

In any event, the pressure is preferably sufficient to press the parison section against the inner walls of the mold, but insufficient to crush the foaming plastic layer. In addition, the pressure is preferably insufficient to significantly reduce growth of cells in the plastic foam layer, i.e., in the example shown, in the central layer.

The gas is then released (FIG. 7), and the vacuum holds the parison section in place against the mold walls during molding. By using only vacuum during the main portion of the cycle, foam is permitted to grow in the central layer, without the internal pressures that are supplied by blow molding (e.g., gas from the hollow tube 34 pressing on the inner walls of the parison section). The use of vacuum also provides good part definition.

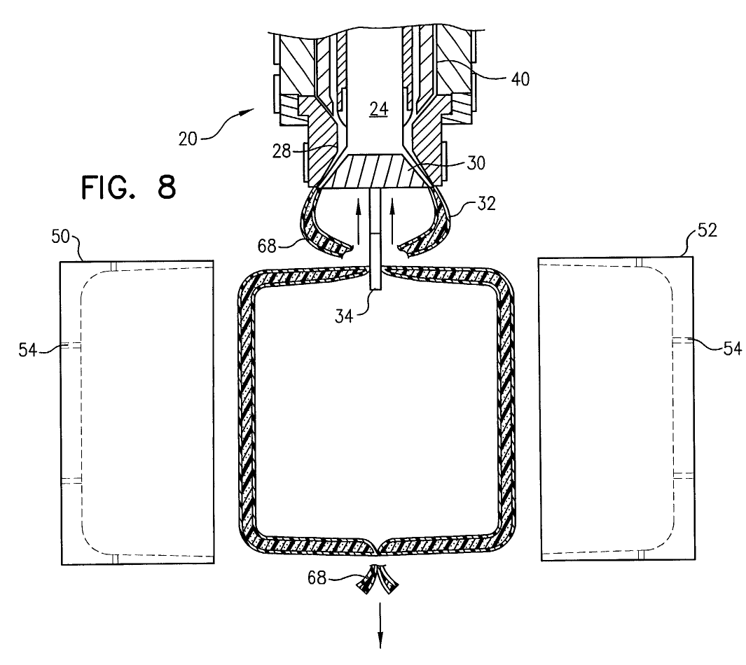

The mold halves 50, 52 are then released from the parison section (FIG. 8), and the excess polymeric material 68 may be machined or otherwise removed, forming the finished part 70 (FIG. 9). It can be understood that the finished part may be cut in half so as to provide two open-faced ed parts, such as might be used for two open-faced coolers. In addition, while the present embodiment is described with reference to providing a substantially cubic or cylindrical part, it can be understood that the teachings of the present invention may be utilized to produce parts of multiple different configurations.

The process of the present invention provides a unique, one-step method for producing insulated containers or parts thereof. Only one machine is need for the production of a multi-layer insulated part, and very little labor is involved in the production of that part.

The present invention also provides a method in which to provide an insulated part using exothermic and endothermic plastic foams. The use of the unique blow-then-vacuum molding technique permits the maximum growth of cells in the insulated layer. An initial, low-pressure blast of air is used to move the parison against the mold walls, where vacuum then holds the parison in place during molding. By using vacuum in the primary molding stages, the plastic foaming layer is free to form cells and expand. Although some blown, internal air may be pumped into the parison section during the primary molding stage, it is preferred that the air be limited or eliminated so that maximum foaming may occur. Using the present method, applicant has been able to produce insulated parts having a foamed plastic layer that is 0.5 inches thick.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims. For example, while the present invention has been described in relation to an insulated, three-layer part, it can be understood that an insulated part using foamed plastic may be produced having any number of layers.

What is claimed is:

1. A method of producing an insulated product comprising:
forming a parison comprising a plastic foam layer;
enclosing a section of the parison within a mold;
blowing gas into the parison to expand the parison section against the inside of the mold;
applying vacuum to the mold to draw the parison section against the mold; and
allowing the parison section to mold while the plastic foam layer expands within the mold.

2. The method of claim 1, wherein at least a portion of molding the parison section occurs substantially independent of internal gas pressure on the parison section.

3. The method of claim 2, wherein gas pressure is not supplied during at least a portion of the molding of the parison section.

4. The method of claim 1, wherein plastic foam layer comprises foamed low density polyethylene.

5. The method of claim 4, wherein the foamed low density polyethylene comprises an endothermic blowing agent.

6. The method of claim 4, wherein the foamed low density polyethylene comprises an exothermic blowing agent.

7. The method of claim 1, wherein the parison comprises inner and outer layers, and wherein the foamed plastic layer is located intermediate the inner and outer layers.

8. The method of claim 7, wherein the inner and outer layers comprise high density polyethylene.

9. The method of claim 8, wherein the inner and outer layers comprise High Load Melt Index (HLMI) high density polyethylene.

10. The method of claim 8, wherein plastic foam layer comprises foamed low density polyethylene.

11. The method of claim 10, wherein the foamed low density polyethylene comprises an endothermic blowing agent.

12. The method of claim 10, wherein the foamed low density polyethylene comprises an exothermic blowing agent.

13. An insulated container, comprising;
an outer layer;
a central layer comprising a foamed thermoplastic resin; and
an inner layer.

14. The insulated container of claim 13, wherein the central layer comprises foamed low density polyethylene.

15. The insulated container of claim 14, wherein the foamed low density polyethylene comprises an endothermic blowing agent.

16. The insulated container of claim 14, wherein the foamed low density polyethylene comprises an exothermic blowing agent.

17. A method of forming a product from plasticized polymer material, comprising:
forming a parison from plasticized polymer material;
enclosing a section of the parison within a mold;
applying gas pressure into the parison to expand the parison section against the inside of the mold;
applying vacuum to the mold to draw the parison section against the mold; and
releasing at least part of the gas pressure and allowing the parison section to mold.

18. The method of claim 17, wherein all of the gas pressure is released during at least part of the molding of the parison section.

19. The method of claim 17, wherein the plasticized polymer material comprises a thermoplastic foamed resin.

20. The method of claim 19, wherein thermoplastic foamed resin comprises foamed low density polyethylene.

21. The method of claim 20, wherein the foamed low density polyethylene comprises an endothermic blowing agent.

22. The method of claim 20, wherein the foamed low density polyethylene comprises an exothermic blowing agent.

23. The method of claim 17, wherein the plasticized polymer material comprises inner and outer layers, and wherein the thermoplastic foamed resin is located intermediate the inner and outer layers.

24. The method of claim 23, wherein the inner and outer layers comprise high density polyethylene.

25. The method of claim 24, wherein the inner and outer layers comprise High Load Melt Index (HLMI) high density polyethylene.

26. The method of claim 24, wherein thermoplastic foamed resin comprises foamed low density polyethylene.

27. The method of claim 26, wherein the foamed low density polyethylene comprises an endothermic blowing agent.

28. The method of claim 26, wherein the foamed low density polyethylene comprises an exothermic blowing agent.
